(19) United States
(12) Patent Application Publication
(10) Pub. No.: US 2011/0298733 A1
(43) Pub. Date: Dec. 8, 2011

(54) TOUCH DISPLAY SYSTEM AND METHOD FOR OPERATING THE SAME

(76) Inventors: Shih-Pin Chen, Taoyuan County (TW); Chi-Pao Huang, Taoyuan County (TW)

(21) Appl. No.: 13/075,158

(22) Filed: Mar. 29, 2011

(30) Foreign Application Priority Data
Jun. 4, 2010 (TW) 099118132

(51) Int. Cl. G06F 3/041

(52) U.S. Cl. 345/173

(57) ABSTRACT

A touch system allows a user to issue touch commands using a cursor pen. The cursor pen is configured to output a characteristic signal which generates a disturbance signal at a contact location where a touch commanded occurs. During a frame period, data driving signals are outputted to the data lines, from which data sensing signals are simultaneously measured for detecting the disturbance signal. If a disturbance signal is detected in a specific data sensing signal, the horizontal coordinate of the contact location may be determined according to a specific data line from which the specific data sensing signal is measured, and the vertical coordinate of the contact location may be determined according to when the disturbance signal occurs in the specific data line.

### BACKGROUND OF THE INVENTION

1. Field of the Invention

The present invention is related to an LCD display system and method for operating the same, and more particularly, to a touch LCD display system and method for operating the same.

2. Description of the Prior Art

Liquid crystal display (LCD) devices, characterized in thin appearance, have gradually replaced traditional bulky cathode ray tube (CRT) displays and been widely used in various electronic products. With increasing demand in product minimization, there is less space available for traditional input devices such as keyboard and mouse. Therefore, touch panels capable of receiving touch commands have been developed for providing users with direct interaction in a display system.

FIG. 1 is a diagram of a prior art LCD device 100. The LCD device 100 includes an LCD panel 110, a gate driver 120, a source driver 130, and a timing controller 140. A plurality of parallel data lines DL₁-DL_{M}, a plurality of parallel gate lines GL₁-GL_{N}, and an M by N pixel array are disposed on the LCD panel 110. The data lines DL₁-DL_{M} and the gate lines GL₁-GL_{N} are disposed perpendicular to each other. The pixel array includes M*N pixels P₁₁⁻P_{MN} which are disposed at respective intersections of the corresponding data lines and gate lines. Each pixel includes a thin film transistor TFT, a liquid crystal capacitor C_{LC} and a storage capacitor C_{ST}. The gate driver 120 is coupled to the gate lines GL₁-GL_{N} and configured to sequentially output gate driving signals S_{G1}-S_{GN} to the gate lines GL₁-GL_{N} according the clock signal generated by the timing controller 140, thereby turning on the thin film transistor switches TFT in the corresponding pixels P₁₁-P_{MN}. The source driver 130 is coupled to the data lines DL₁-DL_{M} and configured to sequentially output data driving signals S_{D1}-S_{DM} to the data lines DL₁-DL_{M} according the clock signal generated by the timing controller 140, thereby charging the pixels P₁₁-P_{MN} for displaying corresponding images.

FIG. 2 is a diagram of a prior art LCD device 200 capable of receiving touch commands. The LCD 200 includes an LCD panel 210, a gate driver 220, a source driver 230, a timing controller 240, and a sensing circuit 250. In order to provide touch function, a plurality of parallel sensing lines S_{X1}-S_{XM}, a plurality of sensing units S₁₁-S_{MN}, and a plurality of thin film transistor TFT₁₁-TFT_{MN} are further disposed on the LCD panel 210. Each of the sensing lines S_{X1}-S_{XM} are disposed between two corresponding adjacent data lines among the data lines DL₁-DL_{M}. The sensing units S₁₁-S_{MN}, configured to detect touch signals, are turned on (short-circuited) when detecting touch signals. The thin film transistor TFT₁₁- TFT_{MN}, whose gates are coupled to the corresponding gate lines, are configured to electrically connect the sensing units S₁₁-S_{MN} to the corresponding sensing lines S_{X1}-S_{XM} or electrically isolate the sensing units S₁₁-S_{MN} from the corresponding sensing lines S_{X1}-S_{XM} according to the scan signals received from the corresponding gate lines. The sensing circuit 250 is coupled to the sensing lines S_{X1}-S_{XM} and configured to calculate where a touch signal occurs according to signals received from the sensing lines S_{X1}-S_{XM}. Compared to the traditional LCD device 100, the sensing lines S_{X1}-S_{XM}, the sensing units S₁₁-S_{MN}, and the thin film transistor TFT₁₁- TFT_{MN} further required in the LCD device 200 for providing touch function increase manufacturing costs.

FIG. 3 is a diagram of a prior art touch system 30. The touch system 30 includes a stylus 35 and an LCD device 300. The LCD device 300 also includes an LCD panel 110, a gate driver 120, a source driver 130, and a timing controller 140. Reference may be made to FIG. 1 for the detailed structure of the LCD panel 110. In order to provide touch function, the LCD device 300 further includes an X position signal transceiver 152, a Y position signal transceiver 154, and a stylus position signal transceiver 156. The X position signal transceiver 152 is configured to superimpose digitization signals to the electrodes of certain data lines, and the Y position signal transceiver 154 is configured to superimpose digitization signals to the electrodes of certain gate lines. The stylus 35 includes a transceiver which, when the stylus 35 approaches or is in contact with the LCD panel 110, is capable of receiving digitization signals and transmitting the received digitization signals to the stylus position signal transceiver 156. The location where the stylus 35 approaches or contacts the LCD panel 110 influences the amount of the induced electromagnetic variations and the received digitization signals vary accordingly. The stylus position signal transceiver 156 may thus identify where the touch command occurs using the stylus 35 according to the variations in the received digitization signals. Compared to the traditional LCD device 100, the X position signal transceiver 152, the Y position signal transceiver 154 and the stylus position signal transceiver 156 further required in the LCD device 300 for providing touch function increase manufacturing costs.

### SUMMARY OF THE INVENTION

The present invention provides a method for operating a touch panel. The touch panel includes a plurality of parallel data lines, a plurality of parallel gate lines disposed perpendicular to the plurality of data lines, and a plurality of pixels arranged in a matrix and disposed at intersections of the plurality of data lines and the plurality of gate lines, and each coupled to a corresponding data line among the plurality of data lines and a corresponding gate line among the plurality of gate lines. The method includes issuing a touch command by contacting the touch panel at a specific location using a cursor pen which provides a characteristic signal, writing a plurality of first signals respectively into the plurality of data lines, scanning the plurality of gate lines according to a clock signal for turning on pixel rows coupled to the plurality of gate lines, reading a plurality of second signals respectively from the plurality of data lines and detecting a disturbance signal associated with the characteristic signal in the plurality of second signals after receiving the touch command, and, when the disturbance signal is detected in a specific second signal read from a specific data line among the plurality of data lines, determining a first coordinate of the specific location according to where the specific data line is disposed on the touch panel, and determining a second coordinate of the specific location according to when the disturbance signal occurs in the specific second signal.

The present invention further provides a touch display system including a cursor pen and a display panel. The cursor pen is configured to provide a characteristic signal and for issuing a touch command by contacting the display panel at a specific location. The display panel includes a plurality of parallel data lines, a plurality of parallel gate lines disposed perpendicular to the plurality of data lines, and a plurality of pixels arranged in a matrix and disposed at intersections of the plurality of data lines and the plurality of gate lines, a gate driver configured to scan the plurality of the gate lines according to a clock signal for turning on pixel rows coupled to the plurality of gate lines, a source driver configured to output a plurality of first signals respectively to the plurality of data lines, and a positioning circuit. The positioning circuit includes a reading circuit configured to read a plurality of second signals respectively from the plurality of data lines after issuing the touch command, and a judging circuit configured to detect a disturbance signal associated with the characteristic signal in the plurality of second signals, and, when the disturbance signal is detected in a specific second signal read from a specific data line among the plurality of data lines, further configured determine a first coordinate of the specific location according to where the specific data line is disposed on the touch panel and determine a second coordinate of the specific location according to when the disturbance signal occurs in the specific second signal.

The present invention further provides a position-detecting device for identifying a disturbance signal in a display device. The position-detecting device includes a timing controller coupled to a plurality of gate lines in the display device and configured to sequentially scan pixels coupled to the plurality of the gate lines, a reading circuit coupled to a plurality of data lines in the display device for detecting the disturbance signal, and a judging circuit coupled to the reading circuit and the timing controller. When the reading circuit detects the disturbance signal during a frame period of the display device, the judging circuit determines a first coordinate of the disturbance signal according to where a specific data line associated with the disturbance signal is disposed on the display device, identifies a specific gate line associated with when the disturbance signal occurs, and determines a second coordinate of the disturbance signal according to where the specific gate line is disposed on the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art LCD device.

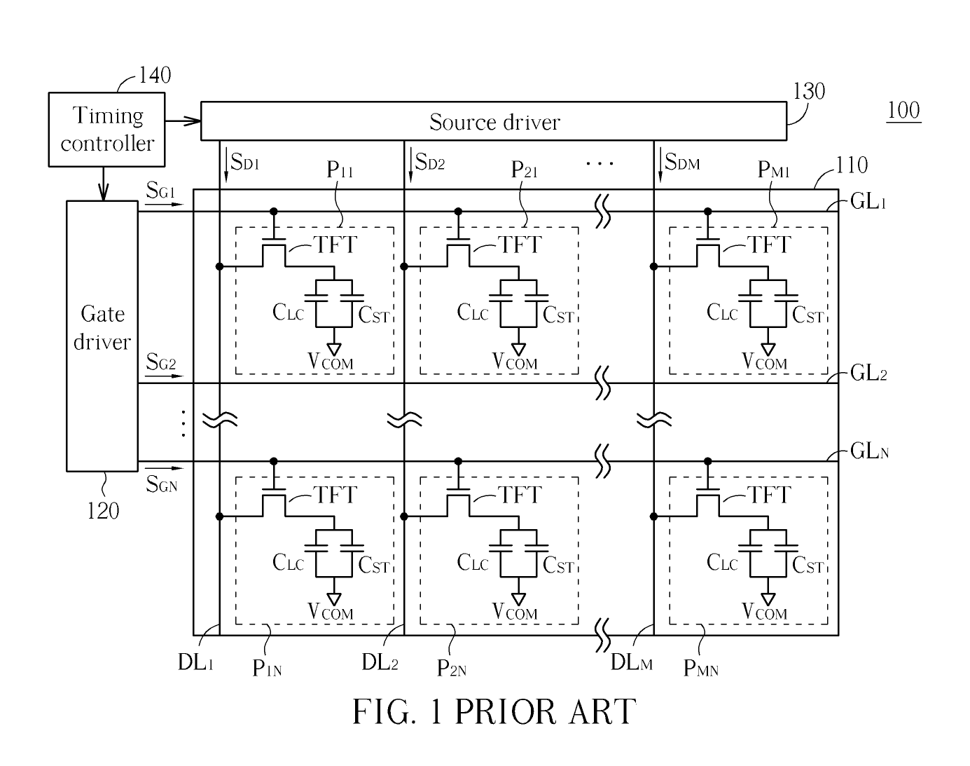

FIG. 2 is a diagram of a prior art LCD device capable of receiving touch commands.

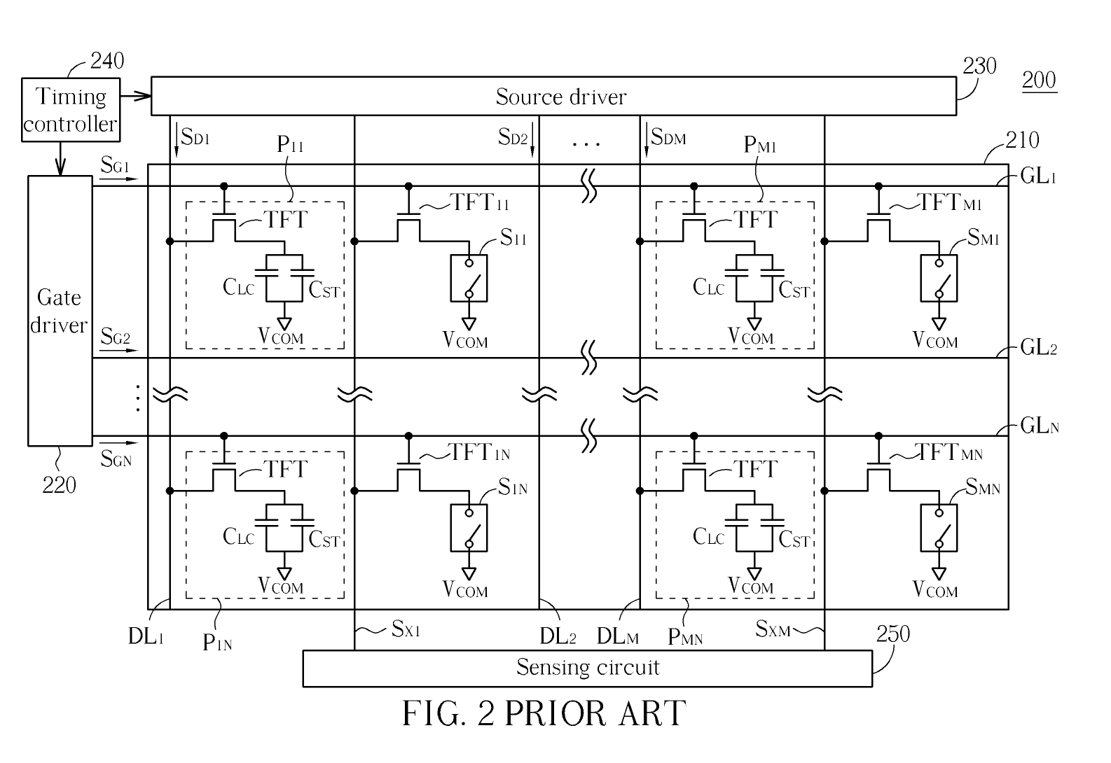

FIG. 3 is a diagram of a prior art touch system.

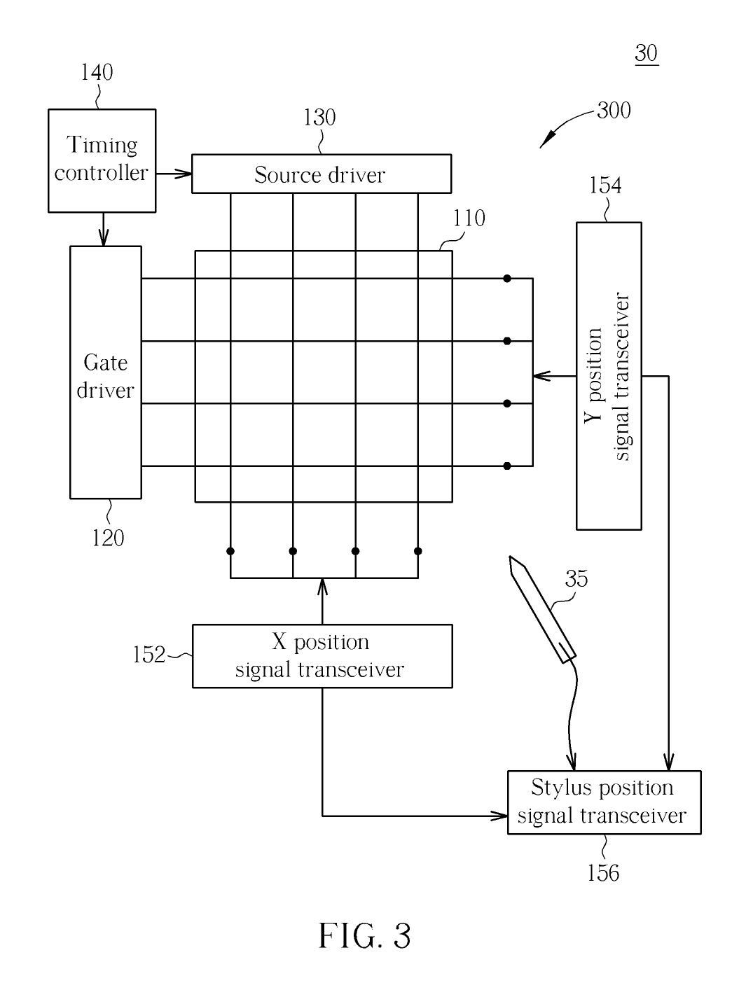

FIG. 4 is a diagram of a touch system according to the present invention.

FIGS. 5a and 5b are diagrams illustrating the operation of a touch system according to the present invention.

FIG. 6 is a diagram illustrating the operation of a judging circuit according to the present invention.

### DETAILED DESCRIPTION

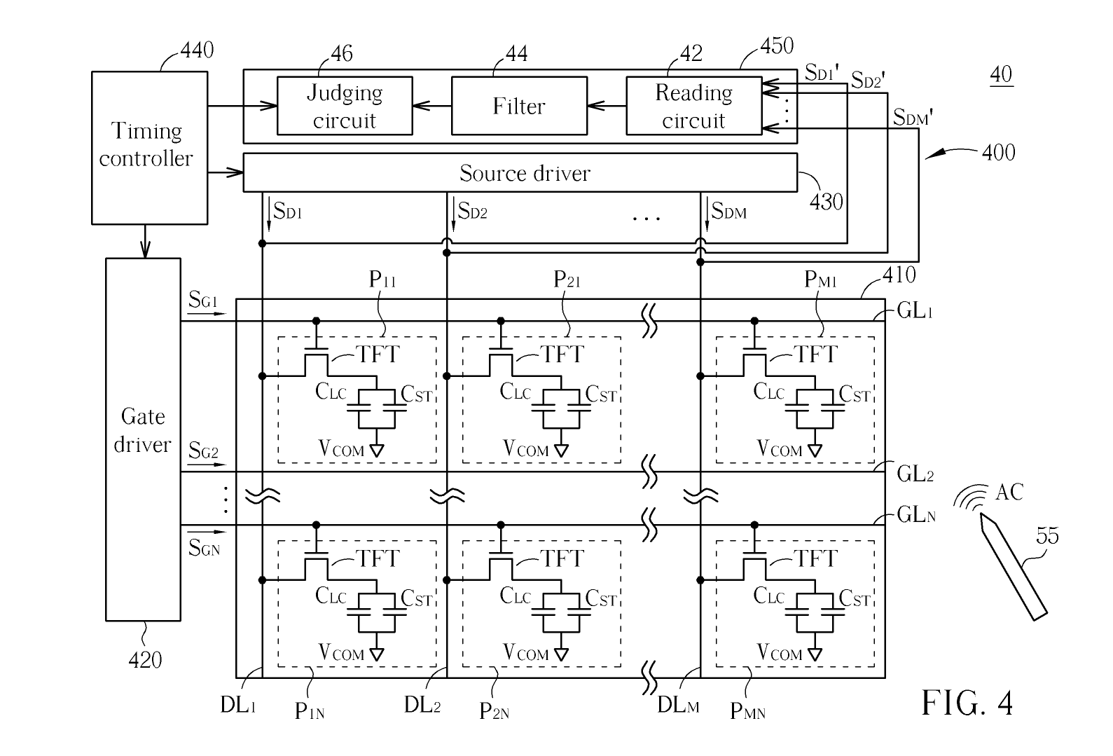

FIG. 4 is a diagram of a touch system 40 according to the present invention. The touch system 40 includes a cursor pen 55 and an LCD device 400. The LCD device 400 includes an LCD panel 410, a gate driver 420, a source driver 430, a timing controller 440, and a positioning circuit 450. A plurality of parallel data lines DL₁-DL_{M}, a plurality of parallel gate lines GL₁-GL_{N}, and an M by N pixel array are disposed on the LCD panel 410. The data lines DL₁-DL_{M} and the gate lines GL₁-GL_{N} are disposed perpendicular to each other. The pixel array includes M*N pixels P₁₁-P_{MN} which are disposed at respective intersections of the corresponding data lines and gate lines. Each pixel includes a thin film transistor TFT, a liquid crystal capacitor C_{LC} and a storage capacitor C_{ST}. Each thin film transistor TFT includes a control end coupled to a corresponding gate line, a first end coupled to a corresponding data line, and a second end. Each liquid crystal capacitor C_{LC} and the storage capacitor C_{ST} are coupled between the second end of a corresponding thin film transistor TFT and a common voltage V_{COM}. The gate driver 420 is coupled to the gate lines GL₁-GL_{N} and configured to sequentially output gate driving signals S_{G1}-S_{GN} to the gate lines GL₁-GL_{N} according the clock signal generated by the timing controller 440, thereby turning on the thin film transistor switches TFT in the corresponding pixels P₁₁-P_{MN}. The source driver 430 is coupled to the data lines DL₁-DL_{M} and configured to sequentially output data driving signals S_{D1}-S_{DM} to the data lines DL₁-DL_{M} according the clock signal generated by the timing controller 440, thereby charging the pixels P₁₁-P_{MN} for displaying corresponding images.

The cursor pen 55 is configured to output a characteristic signal, such as an alternative-current pulse signal AC whose frequency is different from that of the data driving signals S_{D1}-S_{DM}. Using the cursor pen 55, a user may issue a touch command at a specific location of the LCD panel 410. In the embodiment illustrated in FIG. 4, the cursor pen 55 is pen-shaped so as to provide easy maneuver. However, the shape of the cursor pen 55 does not limit the scope of the present invention.

The positioning circuit 450 includes a reading circuit 42, a filter 44, and a judging circuit 46. The reading circuit 42 is configured to read the data sensing signals S_{D1}′-S_{DM}′ respectively from the data lines DL₁-DL_{M} within the frame period of the LCD device 400 (such as 16 ms) . The filter 44 is configured to block the data sensing signals S_{D1}′-S_{DM}′ whose frequencies are different from that of the characteristic signal. For example, if the characteristic signal outputted by the cursor pen 55 is an alternative-current pulse signal AC whose frequency is much higher than that of the data driving signals S_{D1}-S_{DM}, the filter 44 may be a high-pass filter. The judging circuit 46 may be a micro-processor coupled to the timing controller 440 and the filter 450. The judging circuit 46 is configured to detect a disturbance signal associated with the characteristic signal among the data sensing signals S_{D1}′-S_{DM}′, thereby determining the contact location of the cursor pen 55 on the LCD panel 410.

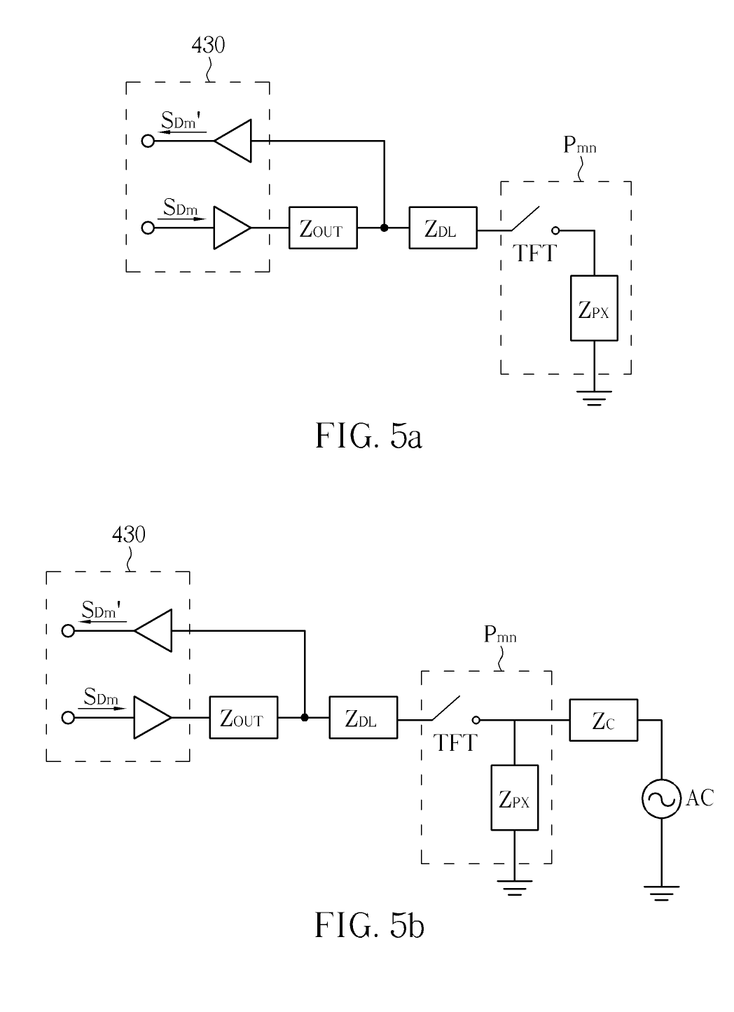

FIGS. 5a and 5b are diagrams illustrating the operation of the touch system 40 according to the present invention. A specific pixel Pₘₙ among the pixels P₁₁-P_{MN} is used for illustration, wherein the pixel Pₘₙ is coupled to a specific data line DLₘ among the data lines DL₁-DL_{M} and a specific gate line GLₙ among the gate lines GL₁-GL_{N} (m is an integer between 1 and M, and n is an integer between 1 and N) . FIG. 5a shows the equivalent circuit of the LCD panel 410 when no touch command is issued. Z_{OUT} represents the output impedance of the source driver 430, Z_{DL} represents the equivalent impedance of the data line DLₘ, and Z_{PX} represents the equivalent impedance of the pixel Pₘₙ. Therefore, when the thin film transistor switch TFT is turned on by the gate driving signal S_{Gn}, the data driving signal S_{Dm} encounters an equivalent impedance of Z_{OUT}+Z_{DL}+Z_{PX}, and the data sensing signal S_{Dm}′ encounters an equivalent impedance of Z_{DL}+Z_{PX}.

FIG. 5b shows the equivalent circuit of the LCD panel 410 when the user issues a touch command by holding the cursor pen 55 in contact with the LCD panel 410 at a location where the pixel Pₘₙ is disposed. Z_{oUT} represents the output impedance of the source driver 430, Z_{DL} represents the equivalent impedance of the data line DLₘ, Z_{PX} represents the equivalent impedance of the pixel Pₘₙ, and Z_{C} represents the equivalent impedance caused by the characteristic signal on the coupling capacitance at the location of the pixel Pₘₙ. Therefore, when the thin film transistor switch TFT is turned on by the gate driving signal S_{Gn}, the data sensing signal S_{Dm}′ encounters an equivalent impedance of Z_{DL}+(Z_{PX}+Z_{C})⁻¹. In other words, when the user issues a touch command at the location of the pixel Pₘₙ, the alternative-current pulse signal AC is coupled to the corresponding data line DLₘ via the equivalent impedance Z_{C}, thereby introducing a corresponding disturbance signal V_{AC} in the data sensing signal S_{Dm}′.

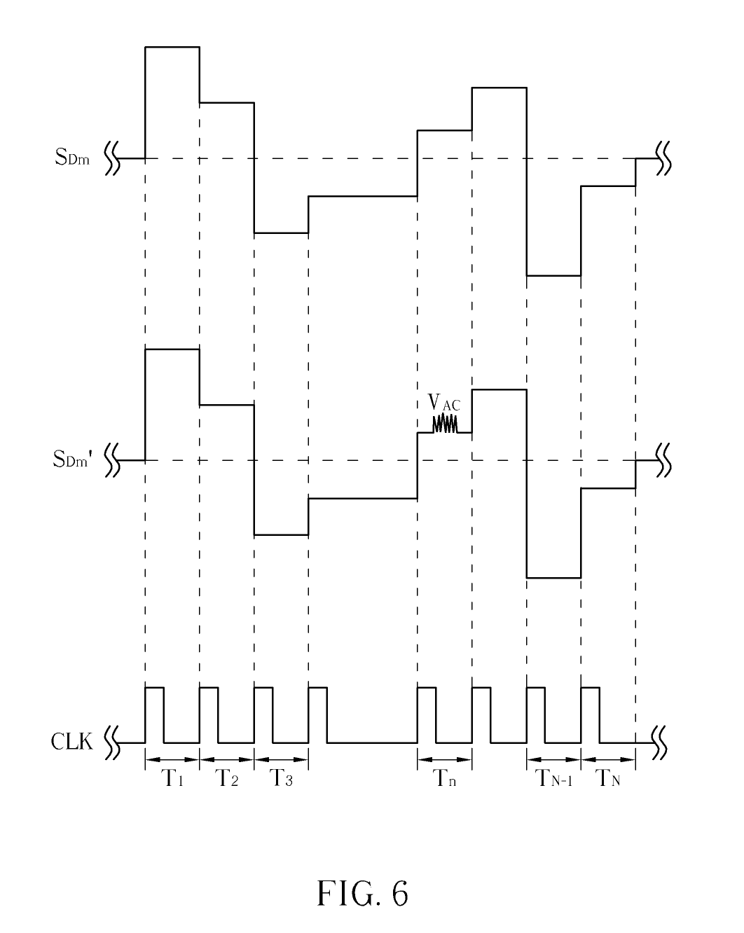

As previous stated, during a frame period when the source driver 430 sequentially outputs the data driving signals S_{D1}-S_{DM} to the corresponding data lines DL₁-DL_{M}, the positioning circuit 450 is configured to simultaneously read the data sensing signals S_{D1}′-S_{DM}′ from the data lines DL₁-DL_{M} using the reading circuit 42, as well as detect the disturbance signal V_{AC} from the data sensing signals S_{D1}′-S_{DM}′ using the judging circuit 46. FIG. 6 illustrates the operation of the judging circuit 46 and depicts a clock signal CLK, a data driving signals S_{Dm} among the data driving signals S_{D1}-S_{DM}, and a data sensing signals S_{Dm}′ among the data sensing signals S_{D1}′-S_{DM}′. The driving periods T₁-T_{N} of the gate lines GL₁-GL_{N} are defined by the clock signal CLK, the data driving signals S_{Dm} is the signal written into the data line DLₘ, and the data sensing signals S_{Dm}′ is the signal read from the data line DLₘ. The waveforms of the signals depicted in FIG. 6 are merely for illustrative purpose and do not limit the scope of the present invention.

A two-dimensional coordinate (x, y) is used for identifying the specific location where the cursor pen 55 comes in contact with the LCD panel 410. If the judging circuit 46 detects the disturbance signal V_{AC} associated with the characteristic signal (such as the alternative-current pulse signal AC), the horizontal coordinate x of the specific location may be determined according to where the corresponding data line DLₘ is disposed on the LCD panel 410. Meanwhile, the judging circuit 46 is able to determine that the disturbance signal V_{AC} occurs in the period Tₙ of the data sensing signals S_{Dm}′ according to the clock signal CLK. The vertical coordinate y of the specific location may be determined according to where the corresponding gate line GLₙ is disposed on the LCD panel 410.

In the touch system 40 according to the present invention, the positioning circuit 450 is configured to identify a touch location by simultaneously reading the data sensing signals from the data lines during a frame period when the source driver 430 outputs the data driving signals to the data lines. When the users issues a touch command on the LCD panel 410 using the cursor pen 55, the characteristic signal generated by the cursor pen 55 influences the electrical field around the contact location, thereby inducing a disturbance signal in corresponding data sensing signals. Therefore, if the disturbance signal is detected in a specific data sensing signal which is measured from a specific data line, the horizontal coordinate of the contact location may be determined according to where the specific data line is disposed on the LCD panel 410. Meanwhile, by referencing when the disturbance signal occurs in the specific data sensing signal with the clock signal, it may be determined that the disturbance signal occurs in the driving period of a specific gate line. The vertical coordinate of the contact location may thus be determined according to where the specific gate line is disposed on the LCD panel 410. Instead of altering pixel layout or using extra position signal transceivers, the touch display system 40 according to the present invention may provide touch function without increasing manufacturing costs.

Those skilled in the art will readily observe that numerous modifications and alterations of the device and method may be made while retaining the teachings of the invention.

What is claimed is:

1. A method for operating a touch panel, wherein:
the touch panel comprises:
a plurality of parallel data lines;
a plurality of parallel gate lines disposed perpendicular to the plurality of data lines; and
a plurality of pixels arranged in a matrix and disposed at intersections of the plurality of data lines and the plurality of gate lines, and each coupled to a corresponding data line among the plurality of data lines and a corresponding gate line among the plurality of gate lines; and
the method comprises:
issuing a touch command by contacting the touch panel at a specific location using a cursor pen which provides a characteristic signal;
writing a plurality of first signals respectively into the plurality of data lines;
scanning the plurality of gate lines according to a clock signal for turning on pixel rows coupled to the plurality of gate lines;
after receiving the touch command, reading a plurality of second signals respectively from the plurality of data lines and detecting a disturbance signal associated with the characteristic signal in the plurality of second signals; and
when the disturbance signal is detected in a specific second signal read from a specific data line among the plurality of data lines, determining a first coordinate of the specific location according to where the specific data line is disposed on the touch panel, and determining a second coordinate of the specific location according to when the disturbance signal occurs in the specific second signal.

2. The method of claim 1 further comprising:
detecting the disturbance signal in the plurality of second signals by comparing each first signal with each corresponding second signal.

3. The method of claim 1 further comprising:
identifying, from the plurality of gate lines, a specific gate line which corresponds to when the disturbance signal occurs in the specific second signal according to the clock signal and determining the second coordinate of the specific location according to where the specific gate line is disposed on the touch panel.

4. The method of claim 1 wherein the characteristic signal provided by the cursor pen is an alternative-current signal whose frequency is higher than that of the plurality of first signals.

5. A touch display system comprising:
a cursor pen configured to provide a characteristic signal and for issuing a touch command by contacting a display panel at a specific location;
the display panel including:
a plurality of parallel data lines;
a plurality of parallel gate lines disposed perpendicular to the plurality of data lines; and
a plurality of pixels arranged in a matrix and disposed at intersections of the plurality of data lines and the plurality of gate lines, each pixel coupled to a corresponding data line among the plurality of data lines and a corresponding gate line among the plurality of gate lines;
a gate driver configured to scan the plurality of the gate lines according to a clock signal for turning on pixel rows coupled to the plurality of gate lines;
a source driver configured to output a plurality of first signals respectively to the plurality of data lines; and
a positioning circuit including:
a reading circuit configured to read a plurality of second signals respectively from the plurality of data lines after issuing the touch command; and
a judging circuit configured to detect a disturbance signal associated with the characteristic signal in the plurality of second signals, and, when the disturbance signal is detected in a specific second signal read from a specific data line among the plurality of data lines, further configured determine a first coordinate of the specific location according to where the specific data line is disposed on the touch panel and determine a second coordinate of the specific location according to when the disturbance signal occurs in the specific second signal.

6. The touch display system of claim 5 wherein the positioning circuit further comprises:
a filter coupled between the reading circuit and the judging circuit and configured to block signals whose frequencies are different than that of the characteristic frequency.

7. The touch display system of claim 5 wherein the characteristic signal provided by the cursor pen is an alternative-current signal whose frequency is higher than that of the plurality of first signals.

8. The touch display system of claim 5 wherein each pixel comprises:
a thin film transistor switch including:
a first end coupled to a corresponding data line among the plurality of data lines;
a second end; and
a control end coupled to a corresponding gate line among the plurality of gate lines;
a liquid crystal capacitor coupled between the second end of the thin film transistor and a common voltage; and
a storage capacitor coupled between the second end of the thin film transistor and the common voltage.

9. A position-detecting device for identifying a disturbance signal in a display device, comprising:
a timing controller coupled to a plurality of gate lines in the display device and configured to sequentially scan pixels coupled to the plurality of the gate lines;
a reading circuit coupled to a plurality of data lines in the display device for detecting the disturbance signal; and
a judging circuit coupled to the reading circuit and the timing controller;
wherein when the reading circuit detects the disturbance signal during a frame period of the display device, the judging circuit determines a first coordinate of the disturbance signal according to where a specific data line associated with the disturbance signal is disposed on the display device , identifies a specific gate line associated with when the disturbance signal occurs, and determines a second coordinate of the disturbance signal according to where the specific gate line is disposed on the display device.

10. The position-detecting device of claim 9 wherein the disturbance signal is induced by a touch operation of the display device, and is an alternative-current signal whose frequency is different from a display frequency of the display device.
